(19) United States
(12) Patent Application Publication
(10) Pub. No.: US 2011/0298799 A1
(43) Pub. Date: Dec. 8, 2011

(54) METHOD FOR REPLACING OBJECTS IN IMAGES

(75) Inventors: Roberto Mariani, Singapore (SG); Richard Roussel, Bangkok (TH)

(73) Assignee: XID TECHNOLOGIES PTE LTD, Singapore (SG)

(21) Appl. No.: 12/996,381

(22) PCT Filed: Jun. 3, 2008
(86) PCT No.: PCT/SG2008/000202

§ 371 Date: Aug. 19, 2011

(51) Int. Cl. G06T 19/20

(52) U.S. Cl. 345/420

(57) ABSTRACT

A method for replacing an object in an image is disclosed. The method comprises obtaining a first image having a first object. The first image is two-dimensional while the first object has feature portions. The method also comprises generating first image reference points on the first object and extracting object properties of the first object from the first image. The method further comprises providing a three-dimensional model being representative of a second image object and at least one of manipulating and displacing the three-dimensional model based on object properties of the first object. The method yet further comprises capturing a synthesized image containing a synthesized object from the at least one of manipulated and displaced three-dimensional model, the synthesized object having second image reference points and registering the second image reference points to the first image reference points for subsequent replacement of the first object with the synthesized object.

### FIELD OF INVENTION

The invention relates to digital image processing systems. More particularly, the invention relates to a method and an image processing system for synthesizing and replacing faces of image objects.

### BACKGROUND

Digital image processing has many applications in a wide variety of fields. Conventional digital image processing systems involve processing two-dimensional (2D) images. The 2D images are digitally processed for subsequent uses.

In one application, digital image processing is used in the field of security for recognising objects such as a human face. In this example, a person's unique facial features are digitally stored in a face recognition system. The face recognition system then compares the facial features with a captured image of the person to determine the identity of that person.

In another application, digital image processing is used in the field of virtual reality where an image of one object such as the human face in an image is manipulated or replaced with another object of another human face. In this manner, a face of a figure in a role-playing game is customizable with a gamer own personalized face.

However, conventional digital image processing systems are susceptible to undesirable errors in identifying the human face or replacing the human face with another human face.

This is notably due to variations in face orientation, pose, facial expression and imaging conditions. These variations are inherent during capturing of the human face by an image-capturing source.

Hence, in view of the foregoing limitations of conventional digital image processing systems, there is a need to provide more desirable performance in relation to face detection and replacement.

### SUMMARY

Embodiments of the invention disclosed herein provide a method and a system for replacing a first object in a 2D image with a second object based on a synthesized three-dimensional (3D) model of the second object.

In accordance with a first embodiment of the invention, a method for replacing an object in an image is disclosed. The method comprises obtaining a first image having a first object, the first image being two-dimensional and the first object having a plurality of feature portions. The method also comprises generating first image reference points on the first object and extracting object properties of the first object from the first image, the object properties comprising object orientation and dimension of the first object. The method further comprises providing a three-dimensional model being representative of a second image object, the three-dimensional model having model control points thereon, and at least one of manipulating and displacing the three-dimensional model based on the object properties of the first object. The method yet further comprises capturing a synthesized image containing a synthesized object from the at least one of manipulated and displaced three-dimensional model, the synthesized object having second image reference points derived from the model control points, the second image reference points being associated with a plurality of image portions of the synthesized object, and registering the second image reference points to the first image reference points for subsequent replacement of the first object in the first image with the synthesized object.

In accordance with a second embodiment of the invention, a machine readable medium for replacing an object in an image is disclosed. The machine readable medium has a plurality of programming instructions stored therein, which when execute, the instructions cause the machine to obtain a first image having a first object, where the first image being two-dimensional and the first object having a plurality of feature portions. The programming instructions also cause the machine to generate first image reference points on the first object and extracts object properties of the first object from the first image, where the object properties comprises object orientation and dimension of the first object. The programming instructions also cause the machine to provide a three-dimensional model being representative of a second image object, where the three-dimensional model has model control points thereon, and at least one of manipulating and displacing the three-dimensional model based on the object properties of the first object. The programming instructions further cause the machine to capture a synthesized image containing a synthesized object from the at least one of manipulated and displaced three-dimensional model, where the synthesized object has second image reference points derived from the model control points, and registers the second image reference points to the first image reference points for subsequent replacement of the first object in the first image with the synthesized object.

### BRIEF DESCRIPTION OF THE DRAWINGS

Embodiments of the invention are disclosed hereinafter with reference to the drawings, in which:

FIGS. 1a and 1b show a graphical representation of a first 2D image having a first object;

FIGS. 2a and 2b shows a graphical representation of a second 2D image having a second object;

FIG. 3 shows a graphical representation of the first 3D mesh;

FIG. 4 shows a graphical representation of the first 3D mesh after global deformation is completed;

FIG. 5 shows a graphical representation of the 3D mesh after the mesh reference points is displaced towards the image reference points;

FIG. 6 shows a graphical representation of a 3D model based on the second object of FIG. 2a; and

FIG. 7 shows a graphical representation of the first image of FIG. 1a with the synthesized object that corresponds to the second object of FIG. 2a.

### DETAILED DESCRIPTION

A method and a system for replacing a first object in a 2D image with a second object based on a synthesized three-dimensional (3D) model of the second object are described hereinafter for addressing the foregoing problems.

For purposes of brevity and clarity, the description of the invention is limited hereinafter to applications related to object replacement in 2D images. This however does not preclude various embodiments of the invention from other applications that require similar operating performance. The fundamental operational and functional principles of the embodiments of the invention are common throughout the various embodiments.

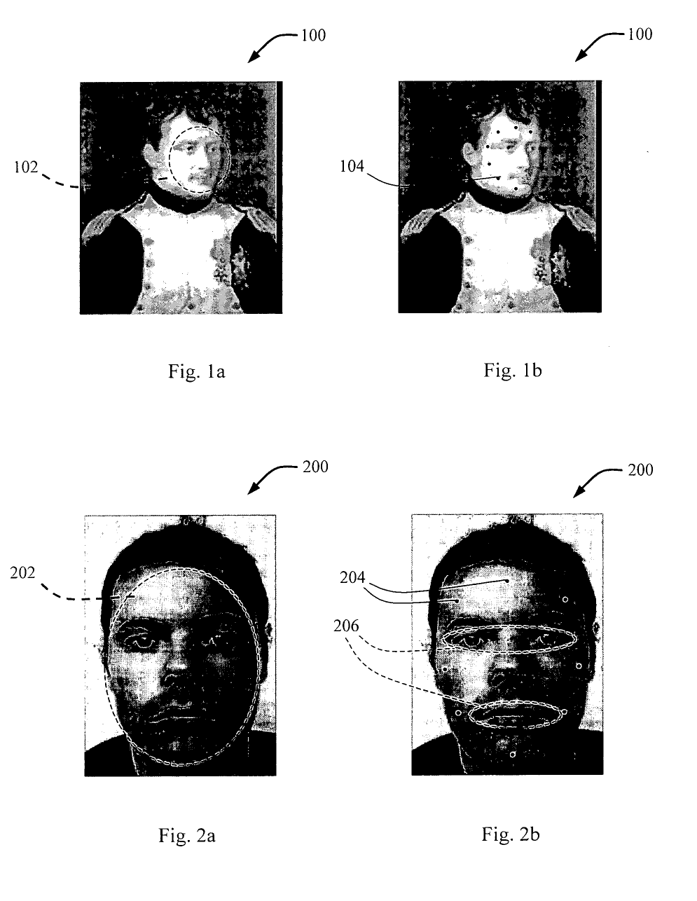

Exemplary embodiments of the invention described hereinafter are in accordance with FIGS. 1a to 7 of the drawings, in which like elements are numbered with like reference numerals.

FIG. 1a shows a graphical representation of a first 2D image 100. The first 2D image 100 is preferably obtained from a first image frame, such as a digital photograph taken by a digital camera or a screen capture from a video sequence. The first 2D image 100 preferably contains at least a first object 102 having first image reference points 104 as shown in FIG. 1b. In a first embodiment of the invention, a system is provided for obtaining the first 2D image 100. The first object 102, for example, corresponds to a face of a first human subject.

The first object 102 of the first 2D image 100 has a plurality of object properties that defines the characteristics of the first face. Examples of the object properties include object orientation or pose, dimension, facial expression, skin colour and lighting of the first face. The system preferably extracts the properties of the first object 102 through methods well known in the art such as knowledge-based methods, feature invariant approaches, template matching methods and appearance-based methods.

FIG. 2a shows a graphical representation of a second 2D image 100. The second 2D image 200 is preferably obtained from a second image frame. The second 2D image preferably contains at least a second object 202 having second image reference points, as shown in FIG. 2b. For example, the second object 202 corresponds to a face of a second human subject having feature portions 206.

Similar to the first object 102, the second object 202 has a plurality of object properties, such as the foregoing ones relating to object orientation, dimension, facial expression, skin colour and lighting. The plurality of object properties defines the characteristics of the face of the second human subject. The system extracts the object properties of the second object 202 for subsequent replacement of the face of the first human subject with the face of the second human subject.

Alternatively, the second 2D image 200 is obtained from the same image frame as the first image frame. In this case, the second 2D image 200 contains two or more objects. More specifically, the second object 202 corresponds to one of the two or more objects contained in the first 2D image 100.

The system preferably stores the respective properties of the first and second objects 102, 202 in a memory. In particular, the system preferably generates the first image reference points 104 on the first 2D image 100, as shown in FIG. 1a. In particular, the first image reference points 104 are used for the subsequent replacement of the face of the first human subject with the face of the second human subject.

The second image reference points 204 of FIG. 2b are preferably marked using a feature extractor. Specifically, each of the second image reference points 204 has 3D coordinates. In order to obtain substantially accurate 3D coordinates of each of the second image reference points 204, the feature extractor first requires prior training in which the feature extractor is taught to identify and mark the second image reference points 204 using training images that are manually labeled and are normalized at a fixed ocular distance. For example, using an image in which there is a plurality of image feature points, each image feature point (x, y) is first extracted using multi-resolution 2D gabor wavelets that are taken in eight different scale resolution and from six different orientations to thereby produce a forty-eight dimensional feature vector.

Next, in order to improve the sharpness of the response of the extraction by the feature extractor around an image feature point (x, y), counter solutions around the region of the image feature point (x, y) are collected and the feature extractor is taught to reject these solutions. All extracted feature vectors (also known as positive samples) of a feature point are then stored in a stack “A” while the feature vectors of counter solutions (also known as negative samples) are stored in a corresponding stack “B”. Both stack “A” and stack “B” are preferably stored in the memory of the system. With the forty-eight dimensional feature vector being produced, dimensionality reduction is required and performed using principal component analysis (PCA). Hence, dimensionality reduction is performed for both the positive samples (PCA_A) and the negative samples (PCA_B).

The separability between the positive samples and the negative samples is optimized using linear discriminant analysis (LDA). The computation of the linear discriminant analysis of the positive samples is performed by first using the positive samples and negative samples as training sets. Two different sets, PCA_A(A) and PCA_A(B), are then created by using the projection of PCA_A. The set PCA_A(A) is then assigned to class “0” while the set PCA_A(B) is assigned to class “1”. The best linear discriminant is defined using the fisher linear discriminant analysis on the basis of a two-class problem. The linear discriminant analysis of the set PCA_A(A) is obtained by computing LDA_A(PCA_A(A)) as the set must generate a “0” value. Similarly, the linear discriminant analysis of the set PCA_A(B) is obtained by computing LDA_A(PCA_A(B)) as the set must generate a “1” value. The separability threshold present between the two classes is then estimated.

Separately, a similar process is repeated for LDA_B. However, instead of using the sets, PCA_A(A) and PCA_A(B), the sets PCA_B(A) and PCA_B(B) are used. Two scores are then obtained by subjecting an unknown feature vector, X, through the following two processes:

X [symbol] PCA_{—}A [symbol] LDA_{—}A (1)

X [symbol] PCA_{—}B [symbol] LDA_{—}B (2)

Ideally, the unknown feature vector, X, gets accepted by the process LDA_A(PCA_A(X)) and gets rejected by the process LDA_B(PCA_B(X)). The proposition is that two discriminant functions are defined for each class using a decision rule that is based on the statistical distribution of the projected data:

f(x)=LDA_{—}A(PCA_{—}A(x)) (3)

g(x)=LDA_{—}B(PCA_{—}B(x) (4)

Set “A” and set “B” are defined as the “feature” and “non-feature” training sets respectively. Further, four one-dimensional clusters are defined: GA=g(A), FB=f(B), FA=f(A) and GB=f(b). The derivation of the mean, x̅, and standard deviation, σ, of each of the four one-dimensional clusters, FA, FB, GA and GB, are then computed. The representations of the means and standard deviations of FA, FB, GA and GB are expressed as ( x̅_{FA}, σ_{FA}), ( x̅_{FB}, σ_{FB}), ( x̅_{GA}, σ_{GA}) and ( x̅_{GB}, σ_{GB}) respectively.

For a given vector Y, the projections of the vector Y using the two discriminant functions are obtained:

yf=f(Y) (5)

yg=g(Y) (6)

### Further, let

$$yfa = \frac{\vert yf - mFA \vert}{sFA} , yfb = \frac{\vert yf - mFB \vert}{sFB} , \\ yga = \frac{\vert yf - mGA \vert}{sGA} and ygb = \frac{\vert yf - mGB \vert}{sGB}$$

The vector Y is classified as to class “A” or “B” according to the pseudo-code expressed as:

if(min(yfa,yga)<min(yfb,ygb))

then

label=A;

else

label=B;

RA=RB=0;

if(yfa>3.09)or(yga>3.09)RA=1;

if(yfb>3.09)or(ygb>3.09)RB=1;

if(RA=1)or(RB=1)label=B;

if(RA=1)or(RB=0)label=B;

if(RA=0)or(RB=1)label=A;

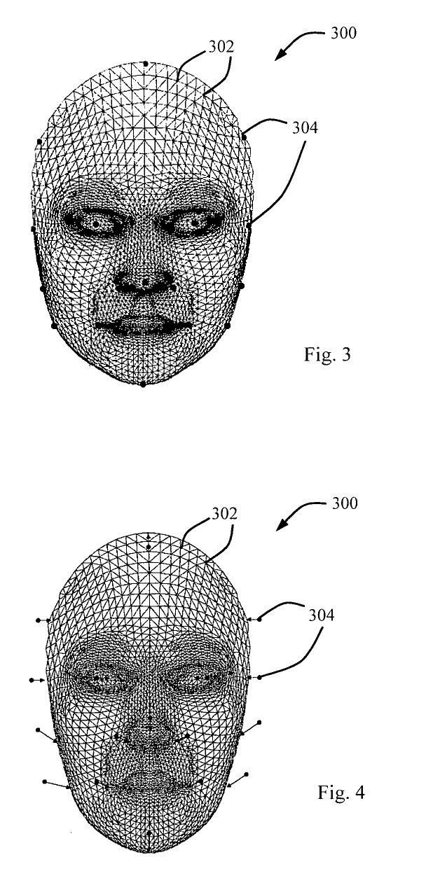

The system subsequently generates a first 3D model or head object of the second 2D image 200. The first 3D model is generated based on the object properties of the first and second objects 102, 202. This is achieved by using a 3D mesh 300, which comprises vertices tessellated for providing the 3D mesh 300 that is deformable either globally or locally. FIG. 3 shows a graphical representation of a first 3D mesh for generating the first 3D model of the second 2D image 200.

The first 3D mesh 300 has predefined mesh reference points 302 and model control points 304 located at predetermined mesh reference points 302. Each of the model control points 304 is used for deforming a predetermined portion of the first 3D mesh 300. More specifically, the system manipulates the model control points 304 based on the orientation and dimension properties of the first object 102.

Global deformation involves, for example, a change in the orientation or dimension of the 3D mesh 300. Local deformation, on the other hand, involves localised changes to a specific portion within the 3D mesh 300.

In this first embodiment of the invention, the system extracts object properties of the first object 102. Global deformation preferably involves object properties that are associated with object orientation and dimension. The system preferably deforms the first 3D mesh 300 for generating the first 3D model based on the global deformation properties of the first object 102.

The object orientation of the first object in the first 2D image 100 is estimated prior to deformation of the first 3D mesh 300. The first 3D mesh 300 is initially rotated along the azimuth angle. The edges of the first 3D mesh 300 are extracted using an edge detection algorithm such as the Canny edge detector. Edge maps are then computed for the first 3D mesh 300 along the azimuth angle from −90 degrees to +90 degrees in increments of 5 degrees. Preferably, the first 3D mesh-edge maps are computed only once and stored in the memory of the system.

To estimate the object orientation in the first 2D image 100, the edges of the 2D image 100 is extracted using the foregoing edge detection algorithm to obtain an image edge map (not shown) of the 2D image 100. Each of the 3D mesh-edge maps is compared to the image edge map to determine which object orientation results in the best overlapping of the 3D mesh-edge maps. To compute the disparity between the 3D mesh-edge maps, the Euclidean distance-transform (DT) of the image edge map is computed. For each pixel in the image edge map, the distance-transform assigns a number that is the distance between that pixel and the nearest nonzero pixel of the image edge map.

The value of the cost function, F, of each of the 3D mesh-edge maps is then computed. The cost function, F, which measures the disparity between the 3D mesh-edge maps and the image edge map is expressed as:

$$F = \frac{{\sum }_{( i , j ) ∈ {A}_{EM}} DT ( i , j )}{N} \qquad ( 7 )$$

where A_{EM}≅{(i, j):EM(i, j)=1} and N is the cardinality of set A_{EM} (total number of nonzero pixels in the 3D mesh-edge map EM). F is the average distance-transform value at the nonzero pixels of the image edge map. The object orientation for which the corresponding 3D mesh-edge map results in the lowest value of F is the estimated object orientation for the first 2D image 100.

Typically, an affine deformation model for the global deformation of the first 3D mesh 300 is used and the image reference points are used for determining a solution for the affine parameters. A typical affine model used for the global deformation is expressed as:

$$[ \begin{matrix}{X}_{gb} \\ {Y}_{gb} \\ {Z}_{gb}\end{matrix} ] = [ \begin{matrix}{a}_{11} & {a}_{12} & 0 \\ {a}_{21} & {a}_{22} & 0 \\ 0 & 0 & \frac{1}{2} {a}_{11} + \frac{1}{2} {a}_{22}\end{matrix} ] [ \begin{matrix}X \\ Y \\ Z\end{matrix} ] + [ \begin{matrix}{b}_{1} \\ {b}_{2} \\ 0\end{matrix} ] \qquad ( 8 )$$

where (X, Y, Z) are the 3D coordinates of the vertices of the first 3D mesh 300, and subscript “gb” denotes global deformation. The affine model appropriately stretches or shrinks the first 3D mesh 300 along the X and Y axes and also takes into account the shearing occurring in the X-Y plane. The affine deformation parameters are obtained by minimizing the re-projection error of the mesh reference points on the rotated deformed first 3D mesh 300 and the corresponding first image reference points 104 in the first 2D image 100. The 2D projection (x_{f}, y_{f}) of the 3D mesh reference points (X_{f}, Y_{f}, Z_{f}) on the deformed first 3D mesh 300 is expressed as:

$$[ \begin{matrix}{x}_{f} \\ {y}_{f}\end{matrix} ] = \underbrace{[ \begin{matrix}{r}_{11} & {r}_{12} & {r}_{13} \\ {r}_{21} & {r}_{22} & {r}_{23}\end{matrix} ]}_{{R}_{12}} [ \begin{matrix}{a}_{11} {X}_{f} + {a}_{12} {Y}_{f} + {b}_{1} \\ {a}_{12} {X}_{f} + {a}_{22} {Y}_{f} + {b}_{2} \\ \frac{1}{2} ( {a}_{11} + {a}_{22} ) {Z}_{f}\end{matrix} ] \qquad ( 9 )$$

where R₁₂ is the matrix containing the top two rows of the rotation matrix corresponding to the property relating to object orientation for the first 2D image 100. Using the 3D coordinates of the first image reference points 104, equation (3) can then be reformulated into a linear system of equations. The affine deformation parameters P=[α₁₁, α₁₂, α₂₁, α₂₂, b₁, b₂]^{T} are then determinable by obtaining a least-squares (LS) solution of the system of equations.

The first 3D mesh 300 is globally deformed according to these parameters, thus ensuring that the resulting 3D model conforms to the approximate shape of the first object 102. FIG. 4 shows a graphical representation of the first 3D mesh 300 after global deformation is completed.

The system then proceeds to deform the first 3D mesh 300 based on object properties of the second object 202 relating to local deformation. The system first identifies and locates the feature portions 206 of the second object 202, as shown in FIG. 2b. The feature portions comprise, for example, the facial expression of the face of the second object 202. Thereafter, the system associates the feature portions 206 to image reference points 204 on the second object 202. Each of the image reference points 202 has a corresponding 3D space position on the first 3D mesh 300.

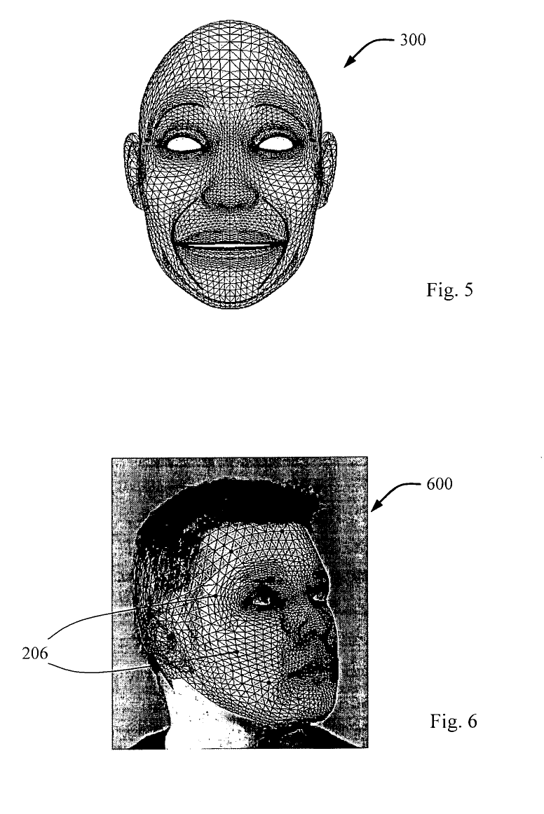

The system subsequently compensates the mesh reference points 302 of the first 3D mesh 300 towards the image reference points. FIG. 5 shows a graphical representation of the 3D mesh after the mesh reference points is displaced towards the image reference points. The system thereafter maps the first object 102 onto the deformed first 3D mesh 300 to obtain the first 3D model 600 of the second object 202. The first 3D model 600 is then manipulated based on the other object properties of the first object 102, such as the foregoing ones relating to position orientation, facial expression, colour and lighting, to obtain the first 3D model 600. FIG. 6 shows a graphical representation of the first 3D model 600.

Alternatively, the system manipulates the first 3D mesh 300 based on the local deformation properties prior to the global deformation properties. This means that the sequence of manipulation is variable for obtaining the first 3D model 600.

The system then captures a synthesized image from the first 3D model 600. The synthesized image contains a synthesized object 700 that has the second image reference points 204. The second image reference points 204 correspond to the first image reference points 104 of the first object 102.

The system then registers the second image reference points 204 to the first image reference points 104. The system subsequently replaces the first object 102 from the first image 100 with the synthesized object 700 that corresponds to the second object 202 to obtain a replaced face within the first image 100.

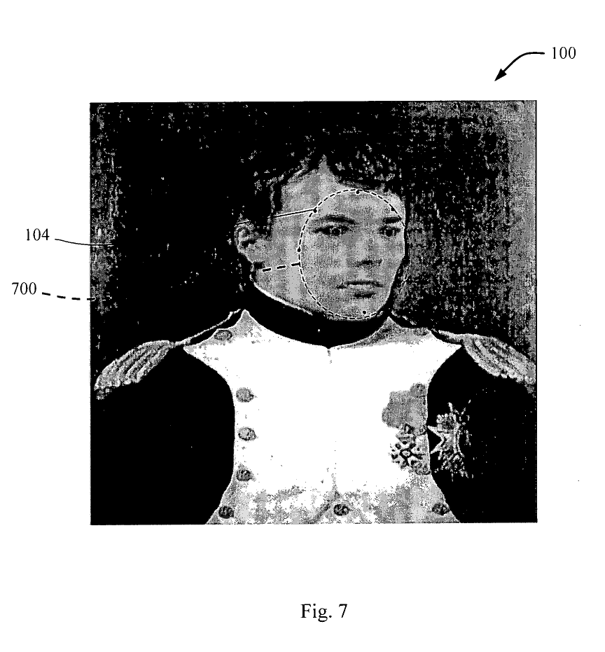

FIG. 7 shows a graphical representation of the first image 100 with the synthesized object 700 that represents the second object 202. In particular, the synthesized object 700 has replaced the first object 102 of the first image 100 while the rest of the first image 100 remained unchanged.

In applications where local deformation properties of the first image 100 are desirable to be present in the replaced face, the system preferably provides a second 3D mesh (not shown) for generating a second 3D model based on the local deformation properties of the first object 102. The second 3D model is then used in the foregoing image processing method based on local deformation for generating the synthesized image containing the synthesized object 700. The synthesized object 700 therefore includes local deformation properties of the first image 100.

Furthermore, the system is capable of processing multiple image frames of a video sequence for replacing one or more object in the video image frames. Each of the multiple image frames of the video sequence is individually processed for object replacement. The processed image frames are preferably stored in the memory of the system. The system subsequently collates the processed image frames to obtain a processed video sequence with the one or more object in the video image frames being replaced.

In the foregoing manner, a method and a system for replacing a first object in a 2D image with a second object based on a synthesized 3D model of the second object are described according to embodiments of the invention for addressing at least one of the foregoing disadvantages. Although only an embodiment of the invention is disclosed, it will be apparent to one skilled in the art in view of this disclosure that numerous changes and/or modification can be made without departing from the spirit and scope of the invention.

1. A method for replacing an object in an image, the method comprising:
obtaining a first image having a first object, the first image being two-dimensional, the first object having a plurality of feature portions;
generating first image reference points on the first object from the plurality of feature portions of the first object;
extracting object properties of the first object from the first image, the object properties comprising object orientation and dimension of the first object;
providing a three-dimensional model being representative of a second image object; the three-dimensional model having model control points thereon;
at least one of manipulating and displacing the three-dimensional model based on the object properties of the first object;
capturing a synthesized image containing a synthesized object from the at least one of manipulated and displaced three-dimensional model, the synthesized object having second image reference points derived from the model control points, the second image reference points being associated with a plurality of image portions of the synthesized object; and
registering the second image reference points to the first image reference points for subsequent replacement of the first object in the first image with the synthesized object.

2. The method as in claim 1, wherein the three-dimensional image is generated using a three-dimensional mesh.

3. The method as in claim 2, wherein displacing the three dimensional model based on object properties of the first object comprises:
matching the three-dimensional mesh with the object properties of the first object.

4. The method as in claim 1, wherein the first image and the second image are substantially identical.

5. The method as in claim 1, wherein the first image and the second image are substantially different.

6. The method as in claim 1, wherein the first image shows at least a portion of a human figure.

7. The method as in claim 1, wherein the first object is a human face.

8. The method as in claim 1, wherein the second image shows at least a portion of a human figure.

9. The method as in claim 1, wherein the second object is a human face.

10. The method as in claim 1, wherein the synthesized image comprises a three-dimensional mesh manipulatable by the model control points.

11. A machine readable medium having stored therein a plurality of programming instructions, which when execute, the instructions cause the machine to:
obtaining a first image having a first object, the first image being two-dimensional, the first object having a plurality of feature portions;
generating first image reference points on the first object from the plurality of feature portions of the first object;
extracting object properties of the first object from the first image, the object properties comprising object orientation and dimension of the first object;
providing a three-dimensional model being representative of a second image object; the three-dimensional model having model control points thereon;
at least one of manipulating and displacing the three-dimensional model based on the object properties of the first object;
capturing a synthesized image containing a synthesized object from the at least one of manipulated and displaced three-dimensional model, the synthesized object having second image reference points derived from the model control points, the second image reference points being associated with a plurality of image portions of the synthesized object; and
registering the second image reference points to the first image reference points for subsequent replacement of the first object in the first image with the synthesized object.

12. The machine readable medium as in claim 1, wherein the three-dimensional image is generated using a three-dimensional mesh.

13. The machine readable medium as in claim 12, wherein the three-dimensional mesh is matched with the object properties of the first object.

14. The machine readable medium as in claim 11, wherein the first image and the second image are substantially identical.

15. The machine readable medium as in claim 11, wherein the first image and the second image are substantially different.

16. The machine readable medium as in claim 11, wherein the first image shows at least a portion of a human figure.

17. The machine readable medium as in claim 11, wherein the first object is a human face.

18. The machine readable medium as in claim 11, wherein the second image shows at least a portion of a human figure.

19. The machine readable medium as in claim 11, wherein the second object is a human face.

20. The machine readable medium as in claim 11, wherein the synthesized image comprises a three-dimensional mesh manipulatable by the model control points.
